(19) United States
(12) Patent Application Publication
(10) Pub. No.: US 2014/0010744 A1
(43) Pub. Date: Jan. 9, 2014

(54) SYSTEM AND METHOD FOR IMPROVING OPERATION OF AN SCR

(71) Applicants: William Charles Ruona, Farmington Hills, MI (US); Michiel J. Van Nieuwstadt, Ann Arbor, MI (US); Devesh Upadhyay, Canton, MI (US)

(72) Inventors: William Charles Ruona, Farmington Hills, MI (US); Michiel J. Van Nieuwstadt, Ann Arbor, MI (US); Devesh Upadhyay, Canton, MI (US)

(73) Assignee: FORD GLOBAL TECHNOLOGIES, LLC, Dearborn, MI (US)

(21) Appl. No.: 13/542,598

(22) Filed: Jul. 5, 2012

(51) Int. Cl. B01D 53/94

(52) U.S. Cl. 423/212; 422/105

(57) ABSTRACT

Methods and systems for improving operation of an SCR are disclosed. In one example, engine hydrocarbon emissions are reduced and/or directed to bypass an SCR so that SCR efficiency can be increased. The methods and systems may reduce NOx emissions of a vehicle via improving SCR efficiency.

### FIELD

The present description relates to improving vehicle emissions. In one example, engine hydrocarbon emissions are stored and/or directed to bypass an SCR so that SCR efficiency may be improved. The approach may be particularly useful to improve NOx emissions after engine starting.

### BACKGROUND/SUMMARY

Current emission control regulations necessitate the use of catalysts in the exhaust systems of automotive vehicles in order to convert carbon monoxide (CO), hydrocarbons (HC), and nitrogen oxides (NOx) produced during engine operation into unregulated exhaust gases. Vehicles equipped with diesel or another lean-burn engines offer the benefit of increased fuel economy, however, control of NOx emissions in these systems is complicated due to the high content of oxygen in the exhaust gas. In this regard, Selective Catalytic Reduction (SCR) catalysts, in which NOx is continuously removed through active injection of a reductant, such as urea, into the exhaust gas mixture entering the catalyst, are known to achieve high NOx conversion efficiency. A typical lean exhaust gas aftertreatment system may also include an oxidation catalyst coupled upstream of the SCR catalyst. The oxidation catalyst converts hydrocarbons (HC), carbon monoxide (CO) and nitrous oxide (NO) in the engine exhaust gas. The oxidation catalyst can also be used to supply heat for fast warm up of the SCR catalyst.

The inventors herein have recognized several disadvantages with such system configuration. Namely, because the oxidation catalyst is typically located under-body far downstream of the engine, it takes a significant time to reach light-off temperatures (e.g. 200 deg. C.). This results in delayed warm up for the SCR catalyst, and thus negatively affects emission control. Also, since the oxidation catalyst does not convert the entering hydrocarbons before reaching light-off temperatures, under some conditions, such as cold starts, or extended periods of light load operation, hydrocarbons may slip from the oxidation catalyst and cause degradation of SCR catalyst operation, reducing the efficiency and useful life of the SCR catalyst.

Accordingly, the inventors herein have developed a system and method for improving operation of an SCR catalyst in a vehicle engine emission system comprising directing engine hydrocarbons to bypass an SCR catalyst via a bypass valve in response to a first condition, and directing engine hydrocarbons through the SCR catalyst in response to a second condition. In one example, the first condition can comprise before an emissions control device in the engine emission system reaches a threshold temperature, and the second condition can comprise after the emissions control device in the engine emission system reaches a threshold temperature. In this manner, degradation of the SCR catalyst can be reduced, improving the efficiency of the SCR catalyst, and reducing the vehicle NOx emissions.

The above advantages as well as other advantages, and features of the present description will be readily apparent from the following Detailed Description when taken alone or in connection with the accompanying drawings.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows a schematic depiction of an engine, including an SCR, and SCR bypass valve;

FIGS. 2A-2F show example vehicle engine emission systems;

FIG. 3 shows a flowchart of an example method for operating a vehicle engine emission system; and

FIGS. 4-5 show example simulated plots of signals of interest when monitoring a vehicle engine emission system.

### DETAILED DESCRIPTION

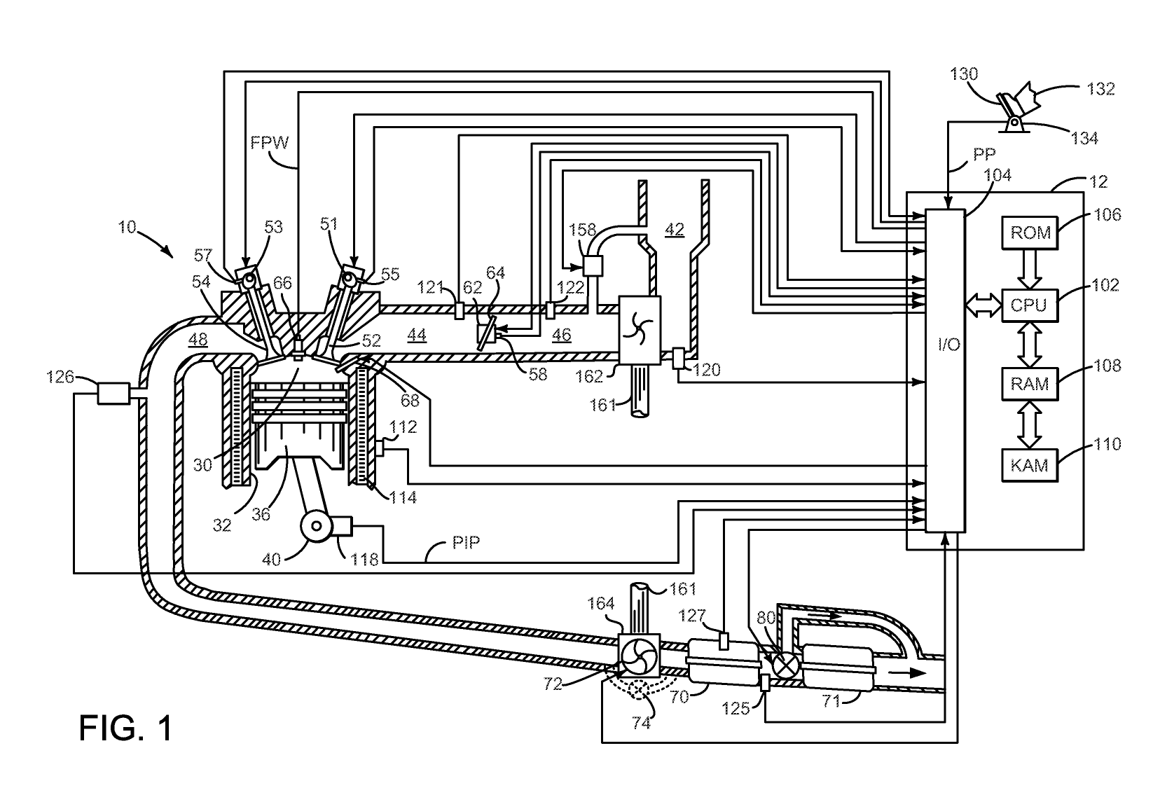

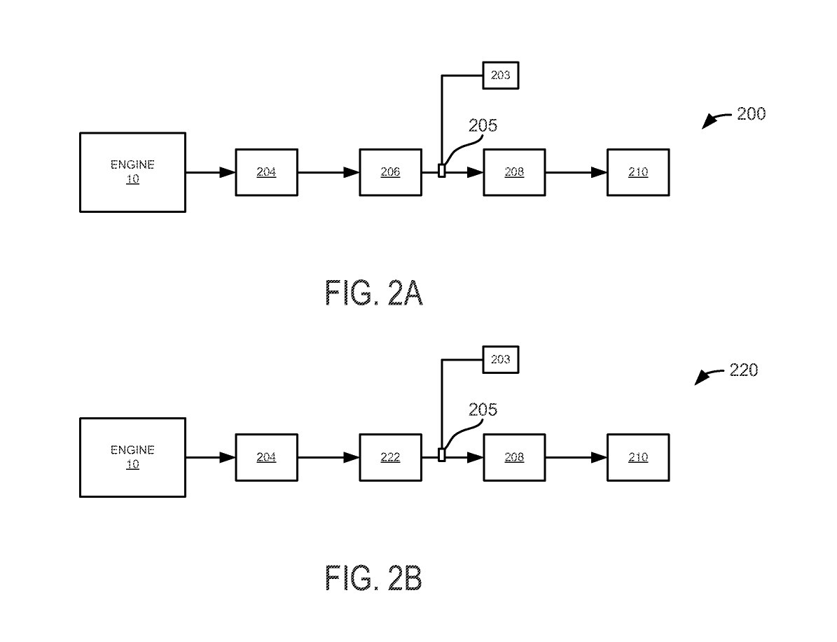

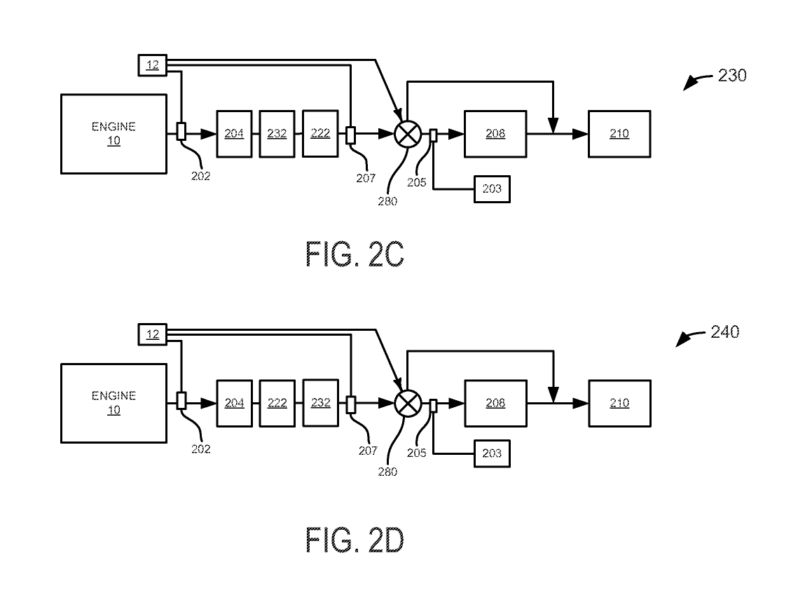

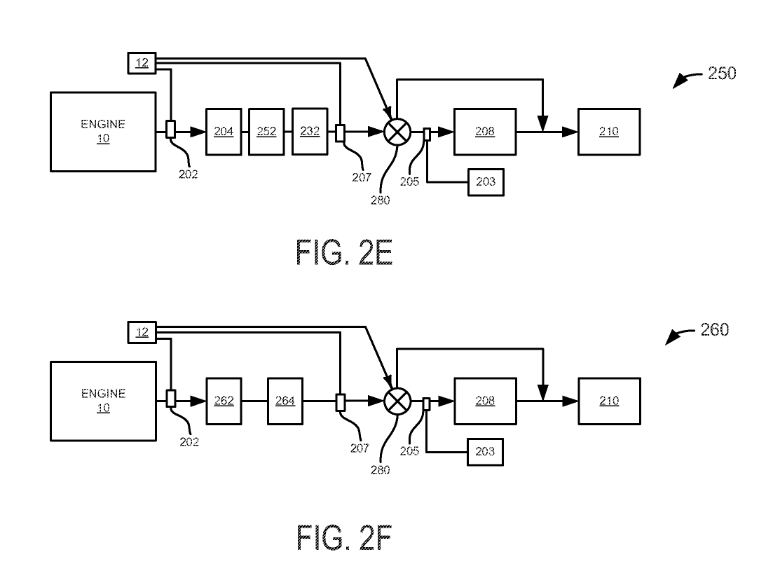

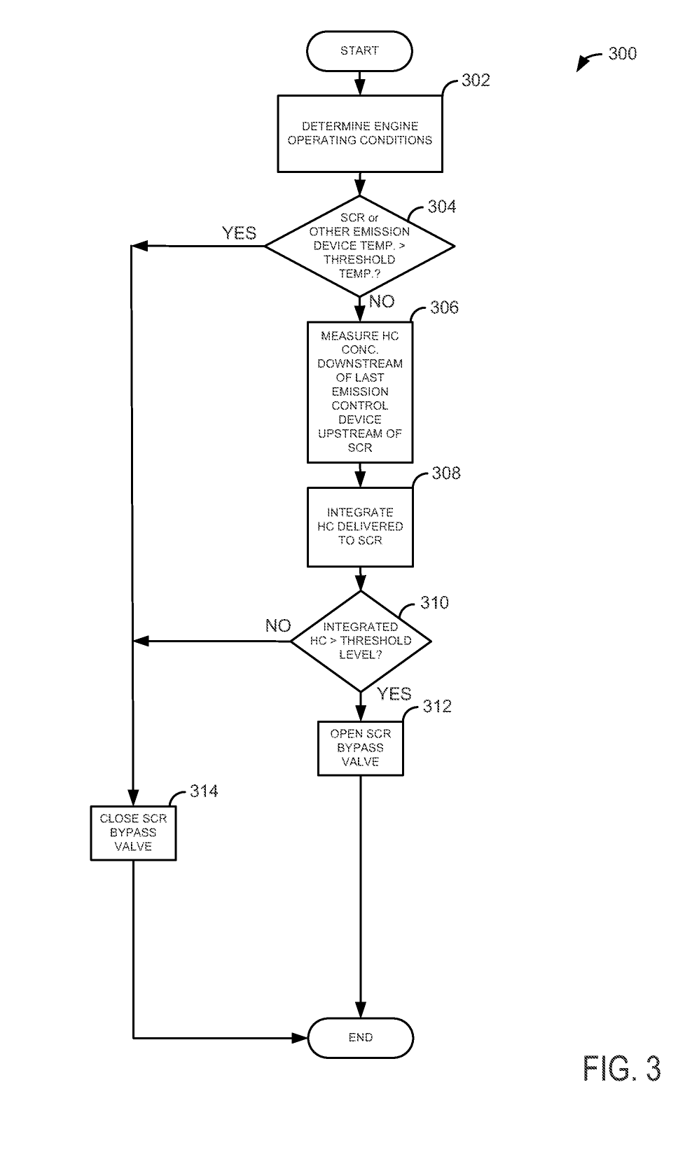

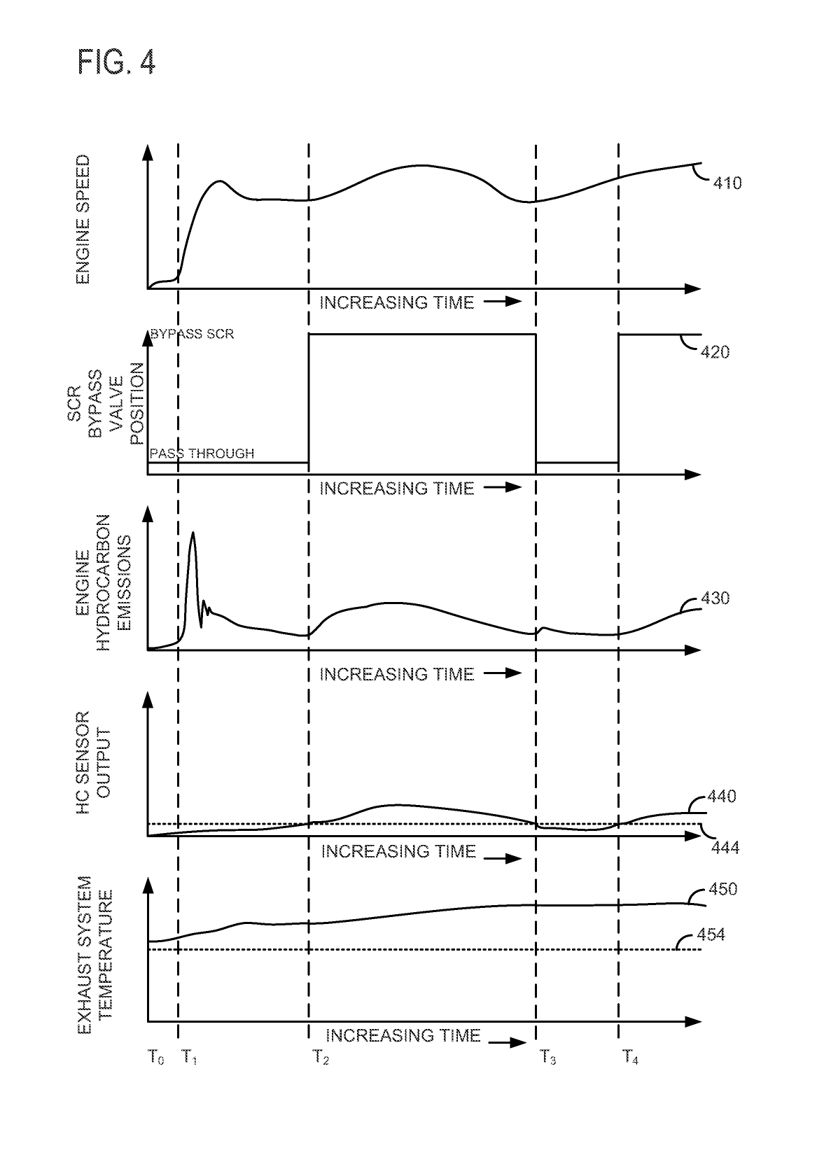

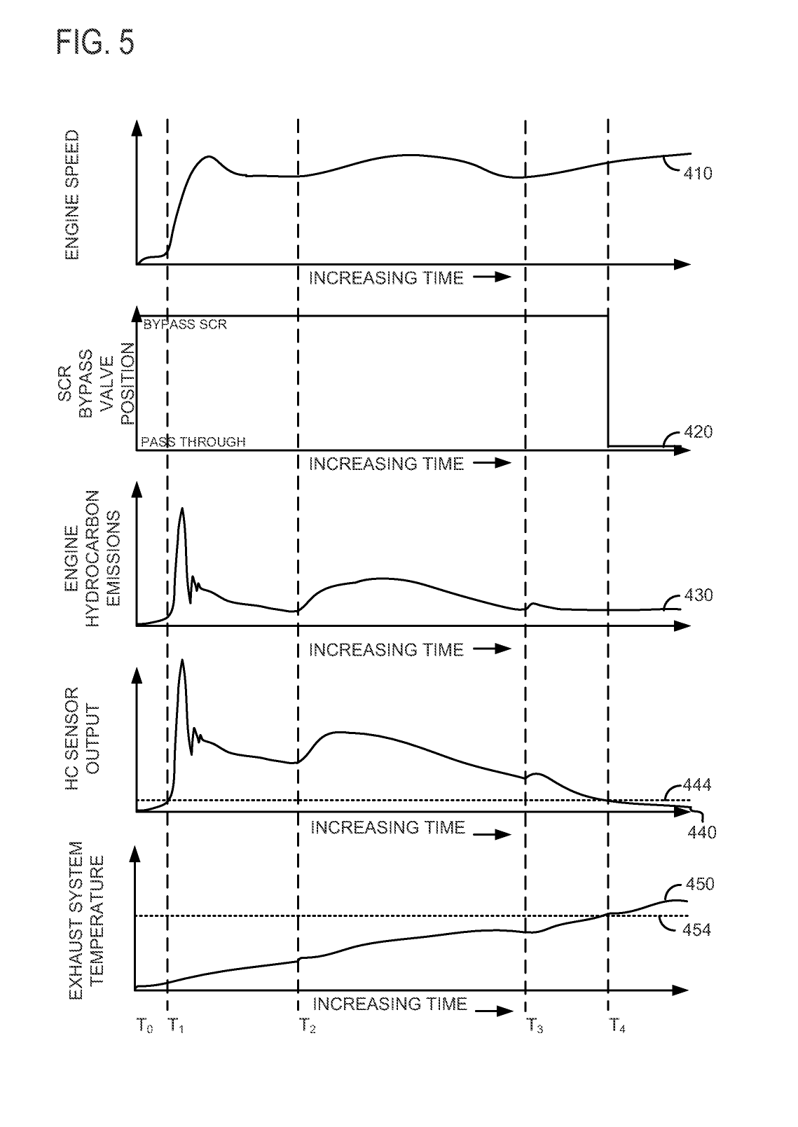

The present description is related to controlling engine emissions of a vehicle. In particular, engine NOx emissions may be reduced via the systems and method described herein. FIG. 1 illustrates one example of an engine although the systems and method disclosed can be applicable to compression ignition engines, compression ignition engines, and turbines. Several example configurations of vehicle engine emission systems including an SCR are shown in FIGS. 2A-2F. FIG. 3 shows an example method for operating the vehicle engine emission systems in 2C-2F comprising an SCR catalyst and an SCR catalyst bypass. Finally, FIGS. 4-5 illustrate example operating sequences according to the method shown in FIG. 3 for operating the vehicle engine emission systems of FIGS. 2C-2F comprising an SCR catalyst and an SCR catalyst bypass.

Referring now to FIG. 1, internal combustion engine 10, comprising a plurality of cylinders, one cylinder of which is shown in FIG. 1, is controlled by electronic engine controller 12. Engine 10 includes combustion chamber 30 and cylinder walls 32 with piston 36 positioned therein and connected to crankshaft 40. Combustion chamber 30 is shown communicating with intake manifold 44 and exhaust manifold 48 via respective intake valve 52 and exhaust valve 54. Each intake and exhaust valve may be operated by an intake cam 51 and an exhaust cam 53. The position of intake cam 51 may be determined by intake cam sensor 55. The position of exhaust cam 53 may be determined by exhaust cam sensor 57.

Fuel injector 66 is shown positioned to inject fuel directly into combustion chamber 30, which is known to those skilled in the art as direct injection. Fuel injector 66 delivers fuel in proportion to the pulse width of signal FPW from controller 12. Fuel is delivered to fuel injector 66 by a fuel system as shown in FIG. 2. Fuel pressure delivered by the fuel system may be adjusted by varying an inlet metering valve regulating flow to a fuel pump (not shown) and a fuel rail pressure control valve.

Intake manifold 44 is shown communicating with optional electronic throttle 62 which adjusts a position of throttle plate 64 to control air flow from intake boost chamber 46. Compressor 162 draws air from air intake 42 to supply boost chamber 46. Exhaust gases spin turbine 164 which is coupled to compressor 162 via shaft 161. In some examples, a charge air cooler may be provided. Compressor speed may be adjusted via adjusting a position of variable vane control 72 or compressor bypass valve 158. In alternative examples, a waste gate 74 may replace or be used in addition to variable vane control 72. Variable vane control 72 adjusts a position of variable geometry turbine vanes. Exhaust gases can pass through turbine 164 supplying little energy to rotate turbine 164 when vanes are in an open position. Exhaust gases can pass through turbine 164 and impart increased force on turbine 164 when vanes are in a closed position. Alternatively, wastegate 74 allows exhaust gases to flow around turbine 164 so as to reduce the amount of energy supplied to the turbine. Compressor bypass valve 158 allows compressed air at the outlet of compressor 162 to be returned to the input of compressor 162. In this way, the efficiency of compressor 162 may be reduced so as to affect the flow of compressor 162 and reduce the possibility of compressor surge.

Combustion is initiated in combustion chamber 30 when fuel ignites without a dedicated spark source such as a spark plug as piston 36 approaches top-dead-center compression stroke and cylinder pressure increases. In some examples, a universal Exhaust Gas Oxygen (UEGO) sensor 126 may be coupled to exhaust manifold 48 upstream of emissions device 70. In other examples, the UEGO sensor may be located downstream of one or more exhaust after treatment devices. Further, in some examples, the UEGO sensor may be replaced by a NOx sensor that has both NOx and oxygen sensing elements.

At lower engine temperatures glow plug 68 may convert electrical energy into thermal energy so as to raise a temperature in combustion chamber 30. By raising temperature of combustion chamber 30, it may be easier to ignite a cylinder air-fuel mixture via compression.

Emissions control device 70 can include a particulate filter and catalyst bricks, in one example. In another example, multiple emissions control devices, each with multiple bricks, can be used. Emissions control device 70 can include an oxidation catalyst in one example. In other examples, the emissions control device may include a lean NOx trap, a hydrocarbon trap, a CO trap, a selective catalyst reduction (SCR) catalyst, and/or a diesel particulate filter (DPF). Although not explicitly shown in FIG. 1, in further examples, other emissions control devices may be located upstream or downstream from the SCR 71. For example, the emissions control device 70 may include an oxidation catalyst and a hydrocarbon trap upstream of SCR 71, whereas a DPF can be located downstream of SCR 71. An SCR bypass valve 80, may be located upstream of SCR 71. The SCR bypass valve 80 may be positioned so that exhaust flow either bypasses SCR 71 or flows through SCR 71. In some examples, SCR 71 may be a urea SCR (U-SCR). In one example, a urea injection system may be provided to inject liquid urea to SCR catalyst 71. However, various alternative approaches may be used, such as solid urea pellets that generate an ammonia vapor, which is then injected or metered to SCR catalyst 71. In still another example, a lean NOx trap may be positioned upstream of SCR catalyst 71 to generate ammonia for the SCR catalyst, depending on the richness of the air-fuel ratio fed to the lean NOx trap. Ammonia may also be generated in a hydrocarbon SCR(HC-SCR) positioned upstream of SCR catalyst 71.

A sensor 125 may be located downstream from emissions control device 70, but upstream of SCR bypass valve 80. Sensor 125 can be a hydrocarbon sensor that communicates with controller 12. In some examples, controller 12 can integrate the signal input from sensor 125, obtaining an integrated level of hydrocarbons over time. In other examples, sensor 125 can also be an oxygen (O₂) sensor, and the oxygen sensor output may be a basis for inferring hydrocarbons. Sensor 127 detects the temperature of emissions control device 70, and communicates with controller 12. Depending on the signals from sensor 125 and/or sensor 127, the controller 12 can operate SCR bypass valve 80 to direct exhaust flow to either bypass or pass through SCR 71. In other examples, sensor 127 may be omitted and SCR temperature may be inferred. Controller 12 may also operate SCR bypass valve 80 to direct exhaust flow to either bypass or flow through SCR 71 based on signals input from exhaust sensor 126 in addition to sensor 125 and sensor 127. As stated above, sensor 126 may be a UEGO sensor or a NOx sensor that has both NOx and oxygen sensing elements. For example, if sensor 125 indicates that the hydrocarbon concentration downstream from an emissions control device 70 upstream from the SCR is above a threshold level, or sensor 127 indicates a temperature of an emissions control device below a threshold temperature (e.g. below DOC light-off temperatures), or sensor 126 indicates low NOx levels in the exhaust, controller 12 may operate SCR bypass valve 80 to direct exhaust flow to bypass SCR 71.

As described above, operation of SCR bypass valve 80 by controller 12 can depend on information received at the controller from sensors 125, 126 and 127. Bypassing the U-SCR 71 under certain exhaust conditions can prolong the life of the U-SCR and efficient operation of the U-SCR, by for example, preventing accumulation of hydrocarbons in the U-SCR. For example, if the exhaust NOx levels are low, as indicated by NOx sensor 126, the SCR bypass can be positioned by controller 12 to direct exhaust flow exiting emissions control device 70 to bypass U-SCR 71. As a further example, if the temperature of the emissions control device 70, as indicated by temperature sensor 127, is below a DOC light-off temperature (e.g. <200° C.) the SCR bypass valve 80 can be positioned by controller 12 to direct exhaust flow exiting emissions control device 70 to bypass U-SCR 71. At low temperatures, the emissions control device 70 comprising an oxidation catalyst may incompletely oxidize hydrocarbons in the exhaust flow. Hydrocarbons can thereby slip past the emissions control device 70 and inhibit U-SCR 71, reducing its operating efficiency for reducing NOx. Hydrocarbons can be present in the exhaust owing to incomplete combustion in the vehicle engine. Additional hydrocarbons (e.g. fuel) may also be injected in-cylinder or post-cylinder. As a further example, if the exhaust hydrocarbon concentration downstream from an emissions control device 70 upstream from the SCR 71 is above a threshold level, as indicated by the hydrocarbon sensor 125, the SCR bypass valve 80 can be positioned by controller 12 to direct exhaust flow exiting emissions control device 70 to bypass U-SCR 71. As previously described, hydrocarbons in the exhaust can inhibit U-SCR 71, reducing its operating efficiency for reducing NOx. Thus, redirecting the exhaust flow to bypass the U-SCR can prolong the efficiency and lifetime of the U-SCR. In a further example, SCR bypass valve 80 can be adjusted by controller 12 to direct exhaust flow to bypass U-SCR 71 if any one of the following conditions exist: low exhaust NOx concentration upstream of SCR 71 indicated by NOx sensor 126 (e.g. NOx concentration below a threshold level); low emissions control device temperature indicated by temperature sensor 127 (e.g. temperature below a threshold temperature); and high exhaust hydrocarbon concentration downstream from an emissions control device 70 upstream from the SCR 71 indicated by hydrocarbon sensor 125 (e.g. hydrocarbon concentration above a threshold level).

Controller 12 is shown in FIG. 1 as a conventional microcomputer including: microprocessor unit 102, input/output ports 104, read-only memory 106, random access memory 108, keep alive memory 110, and a conventional data bus. Controller 12 is shown receiving various signals from sensors coupled to engine 10, in addition to those signals previously discussed, including: engine coolant temperature (ECT) from temperature sensor 112 coupled to cooling sleeve 114; a position sensor 134 coupled to an accelerator pedal 130 for sensing accelerator position adjusted by foot 132; a measurement of engine manifold pressure (MAP) from pressure sensor 121 coupled to intake manifold 44; boost pressure from pressure sensor 122 exhaust gas oxygen concentration from oxygen sensor 126; an engine position sensor from a Hall effect sensor 118 sensing crankshaft 40 position; a measurement of air mass entering the engine from sensor 120 (e.g., a hot wire air flow meter); and a measurement of throttle position from sensor 58. Barometric pressure may also be sensed (sensor not shown) for processing by controller 12. In a preferred aspect of the present description, engine position sensor 118 produces a predetermined number of equally spaced pulses every revolution of the crankshaft from which engine speed (RPM) can be determined.

During operation, each cylinder within engine 10 typically undergoes a four stroke cycle: the cycle includes the intake stroke, compression stroke, expansion stroke, and exhaust stroke. During the intake stroke, generally, the exhaust valve 54 closes and intake valve 52 opens. Air is introduced into combustion chamber 30 via intake manifold 44, and piston 36 moves to the bottom of the cylinder so as to increase the volume within combustion chamber 30. The position at which piston 36 is near the bottom of the cylinder and at the end of its stroke (e.g. when combustion chamber 30 is at its largest volume) is typically referred to by those of skill in the art as bottom dead center (BDC). During the compression stroke, intake valve 52 and exhaust valve 54 are closed. Piston 36 moves toward the cylinder head so as to compress the air within combustion chamber 30. The point at which piston 36 is at the end of its stroke and closest to the cylinder head (e.g. when combustion chamber 30 is at its smallest volume) is typically referred to by those of skill in the art as top dead center (TDC). In a process hereinafter referred to as injection, fuel is introduced into the combustion chamber. In some examples, fuel may be injected to a cylinder a plurality of times during a single cylinder cycle. In a process hereinafter referred to as ignition, the injected fuel is ignited by compression ignition resulting in combustion. During the expansion stroke, the expanding gases push piston 36 back to BDC. Crankshaft 40 converts piston movement into a rotational torque of the rotary shaft. Finally, during the exhaust stroke, the exhaust valve 54 opens to release the combusted air-fuel mixture to exhaust manifold 48 and the piston returns to TDC. Note that the above is described merely as an example, and that intake and exhaust valve opening and/or closing timings may vary, such as to provide positive or negative valve overlap, late intake valve closing, or various other examples. Further, in some examples a two-stroke cycle may be used rather than a four-stroke cycle.

Referring now to FIGS. 2A-2F, several example configurations of vehicle engine emission systems for improving operation of an SCR are shown. In FIG. 2A a first example configuration 200 for a vehicle engine emission system is shown, wherein exhaust gas flows sequentially from an engine 10 through a diesel oxidation catalyst (DOC) 204, a hydrocarbon SCR catalyst (HC-SCR) 206, a urea SCR catalyst (U-SCR) 208, and a DPF 210. DOC 204 may comprise, for example, a porous zeolite or other ceramic-based material whose surface is coated with a catalytically active amount of Pt or Pd or combinations of both metals. Metals other than Pt or Pd, or combinations thereof, may also be used. DOC 204 converts uncombusted hydrocarbons in the engine exhaust gas, oxidizing the hydrocarbons to carbon dioxide and water. Additionally, carbon monoxide (CO) in the engine exhaust may be oxidized to carbon dioxide (CO₂) in DOC 204. Other species present in the exhaust gas such as nitrogen oxide, sulfur compounds, and polyaromatic hydrocarbons may also be oxidized as they pass through the DOC 204. DOC 204 can be positioned upstream of U-SCR 208 since oxidation reactions are favored under lean conditions (e.g., conditions where O₂ concentrations in excess of stoichiometric exhaust conditions exist). DOC 204 is most effective when its temperature is higher than a threshold temperature (e.g., approximately 200° C., the light-off temperature for the hydrocarbon oxidation reaction). At temperatures below the threshold temperature, hydrocarbons may slip or pass through the DOC 204 unreacted. The temperature of DOC 204 may be measured and communicated to the controller 12 by temperature sensor 127.

Next, NOx components in the exhaust are reduced in HC-SCR 206, the hydrocarbons in the exhaust serving as reductants, thereby converting the exhaust NOx and hydrocarbons to nitrogen gas (N₂), carbon dioxide (CO₂), and water (H₂O). Under lean conditions, hydrocarbons can be injected upstream (e.g., in-cylinder and/or post-cylinder) of the HC-SCR 206 (e.g., in-cylinder or post-cylinder) to supply additional reductant for the HC-SCR 206 reaction. Oxygen sensors at 126 and/or at 127 may be used to measure and communicate the oxygen levels (e.g., indicating lean or rich conditions) in the exhaust to controller 12. HC-SCR 206 can thus scavenge unreacted hydrocarbons that slip unreacted through DOC 204, for example when temperatures are lower than a threshold temperature, the hydrocarbons being consumed in NOx reduction reactions and thereby prevented from passing through U-SCR 208 downstream. Accordingly, HC-SCR 206 may adsorb and store exhaust hydrocarbons during cold starts (e.g., before a temperature has reached a threshold temperature) or when the exhaust hydrocarbon concentration is above a threshold level, both examples of conditions where oxidation of exhaust hydrocarbons upstream of the U-SCR may be incomplete. HC-SCR 206 may comprise any suitable catalyst material capable of providing a hydrocarbon selective catalyst reduction of NOx, including copper zeolite, platinum group metal (PGM), alumina-supported silver, aluminum-supported platinum, and other transition metal-based catalysts such as copper, chromium, iron, cobalt, etc., and mixtures thereof supported on refractory oxides (e.g., alumina, zirconia, silica-alumina, titania). The HC-SCR 206 may also comprise a ceramic matrix, including a zeolite. Other examples of catalyst materials known in the art to provide hydrocarbon selective catalytic reduction of NOx or combinations thereof may also be used.

Downstream of HC-SCR 206 is selective catalytic reduction catalyst, U-SCR 208. U-SCR 208 may function similarly to SCR 71 depicted in FIG. 1. U-SCR 208 can further reduce NOx components in the exhaust gas using ammonia as a reductant. The ammonia is formed in the exhaust from decomposing urea that is injected into the exhaust flow via a urea dosing injector 205. Urea dosing injector 205 delivers urea from a urea storage tank 203, and is located upstream from U-SCR 208. Under certain conditions, ammonia can also be generated during the reduction of NOx by hydrocarbons in the HC-SCR 206. Upon injection into the exhaust, the urea decomposes, forming ammonia and carbon dioxide. The urea may be injected at a location in the exhaust far enough upstream from the U-SCR 208 to allow the urea decomposition to occur before entering U-SCR 208. Urea injection dosage may be controlled dependent on the level of NOx in the exhaust just upstream from U-SCR 208. Accordingly, the amount of urea injected may be regulated by a urea dosing control algorithm executed onboard the controller 12. The vehicle engine emission system may further comprise NOx, urea and/or ammonia sensors just upstream from U-SCR 208. The urea dosing control system may receive inputs from urea or ammonia sensors to quantify the urea or ammonia dosage delivered to the exhaust system. An injection amount of urea that is too low may result in a NOx conversion efficiency that is too low to meet regulation standards. On the other hand, an injection amount of urea that is too high may result in urea deposits in the system which may also decrease NOx efficiency and increase urea slip, as well as generate increased white smoke in the exhaust at high temperatures when the deposit is decomposed and released. Further, injection of too much urea may increase urea consumption thereby reducing urea economy. Urea tank 203 may be refilled during periodic vehicle service. After exiting U-SCR 208, the exhaust gas passes through DPF 210. DPF 210 removes particulate matter or soot from the exhaust gas. DPF 210 may be a cordierite, ceramic fiber, silicon carbide, metal fiber, or other type of diesel particulate filter.

Thus in the first configuration 200 of a vehicle engine emission system, HC-SCR 206, located upstream of U-SCR 208, consumes unreacted hydrocarbons via NOx reduction before they reach the U-SCR 208. In this manner, in response to a first condition where the exhaust temperature is low (e.g., during cold starts before the exhaust temperature has reached a threshold temperature) and/or where the concentration of hydrocarbons in the exhaust is above a threshold level, exhaust hydrocarbons can be consumed via oxidation in DOC 204 and/or reduction in HC-SCR 206, preventing them from passing downstream through U-SCR 208. In a further example, the first condition may also comprise conditions where NOx levels are below a NOx threshold level (e.g., below regulated NOx emission limits). The NOx threshold level may also refer to an integrated NOx threshold level, and NOx sensor 202 may measure an integrated NOx concentration in the exhaust.

Referring now to FIG. 2B, a second configuration 220 of a vehicle engine emission system is illustrated, wherein exhaust gas flows sequentially from an engine 10 through DOC 204, a hydrocarbon (HC) trap 222, U-SCR 208 and DPF 210. Second configuration 220 differs from the first configuration 200 in that HC trap 222, in place of HC-SCR 206, is located downstream of DOC 204 and upstream of U-SCR 208. HC trap 222 may comprise a zeolite, which acts as a molecular sieve, trapping hydrocarbon molecules in the zeolite pores. Accordingly, during cold starts or other vehicle operating conditions when the exhaust gas and DOC 204 temperatures are low, hydrocarbons slipping past DOC 204 will become entrapped in HC trap 222. HC trap 222 can thereby prevent exhaust hydrocarbons from reaching the U-SCR in response to a first condition where the temperature is below a threshold temperature and/or where the hydrocarbon concentration downstream from an emissions control device upstream from the U-SCR 208 is above a threshold level, or further still, when the NOx concentration upstream from the U-SCR 208 is below a threshold NOx level (e.g., below the regulated NOx emission level).

Referring now to FIG. 2C, a third configuration 230 of a vehicle engine emission system is shown, wherein an exhaust gas flows sequentially from an engine 10 through a diesel oxidation catalyst (DOC) 204, a carbon monoxide (CO) trap 232, and an HC trap 222. Next, an SCR bypass valve 280 directs the exhaust flow either to bypass or flow through U-SCR 208, after which the exhaust flows though DPF 210. As in configuration 200, urea is stored in urea storage tank 203 and delivered to the system via urea dosing injector 205. The urea may decompose in the exhaust flow, forming ammonia and carbon dioxide. Ammonia may also be formed upstream under rich conditions during desorption and reduction of NOx in CO trap 232. In the third configuration 230, carbon monoxide in the exhaust gas exiting DOC 204 may be retained, among other components, inside CO trap 232. Examples of CO trap 232 include a zeolite molecular sieve or a lean NOx catalyst (LNT). LNT's may comprise an adsorbent alkaline earth compound (e.g. BaCO₃) and a precious metal catalyst (e.g. Pt, Rh, and the like). In addition to trapping CO, an LNT may adsorb NOx components under lean conditions. Conversely, during rich conditions, the LNT may desorb and reduce NOx, wherein the NOx is reduced by hydrocarbons in the exhaust converting them to nitrogen carbon dioxide and water. Ammonia may also be produced in an LNT under rich exhaust conditions during NOx reduction and desorption. HC trap 222 may be located downstream from CO trap 232. During a first condition, where the emissions control device temperature is less than a threshold temperature (e.g., below DOC light-off temperatures), and/or where the hydrocarbon concentration is above a threshold level, hydrocarbons and other components in the exhaust gas can slip past DOC 204. These slipped hydrocarbons may be trapped by HC trap 222, while slipped CO may be trapped by CO trap 232. CO trap 232 may also adsorb NOx components from the exhaust gas. Sensor 202 may be configured to measure temperature and/or NOx levels in the exhaust and to communicate with controller 12. Sensor 202 may be located upstream of DOC 204 as shown in FIGS. 2C-2F, or at DOC 204, where it can measure the temperature of DOC 204. Sensor 202 may also be located at U-SCR 208, where it can measure the temperature of U-SCR 208. Sensor 207 may be a hydrocarbon sensor located downstream from HC trap 222 and/or CO trap 232, but upstream from SCR bypass valve 280. Accordingly, sensor 207 may be located downstream of the last emissions control device upstream of the U-SCR catalyst 208. Sensor 207 can measure the hydrocarbon concentration in the exhaust and communicate with controller 12. In some examples, controller 12 can integrate the signal input from sensor 207, obtaining an integrated level of hydrocarbons over time, or sensor 207 may perform the integration and pass the integrated value to controller 12. The threshold level may comprise an integrated hydrocarbon concentration threshold level. In other examples, controller 12 may determine when hydrocarbon concentration is greater than a threshold hydrocarbon level. In still other examples, sensor 207 can also be an oxygen (O₂) sensor, and the threshold level can comprise an oxygen concentration threshold level or an integrated oxygen concentration threshold level. Further still, the first condition may correspond to conditions where the NOx exhaust concentration is below a NOx threshold level or an integrated NOx threshold level. For example, the NOx threshold level may correspond to the regulated NOx emission level. The NOx concentration can be measured by sensor 202, downstream from the engine but upstream from DOC 204, having a similar function to sensor 126 in FIG. 1.

SCR bypass valve 280 can be located downstream from sensor 207 and may be opened and closed by controller 12. Controller 12 may manipulate SCR bypass valve 280 so that exhaust flow bypasses U-SCR 208 in response to a first condition where the temperature (e.g., temperature sensor 202) is less than a threshold temperature. Conversely controller 12 may manipulate the SCR bypass valve 280 so the exhaust passes through U-SCR 208 in response to a second condition where the temperature (e.g. temperature sensor 202) reaches or exceeds the threshold temperature. As such, during cold engine starts, where the emissions control device temperature is below the threshold temperature (e.g., where DOC 204 temperature and/or U-SCR 208 temperature is below a threshold temperature) exhaust flow may be directed to bypass U-SCR 208. When the engine warms after a period of vehicle operation, for example, where the DOC 204 and/or U-SCR 208 temperatures reach the threshold temperatures, controller 12 may direct exhaust flow to pass through U-SCR 208 via SCR bypass valve 280. Alternately, the first condition may correspond to a condition during which an exhaust hydrocarbon concentration downstream of an emissions control device and upstream of the SCR may be above a threshold level and the second condition may correspond to a condition during which a hydrocarbon concentration downstream of an emissions control device and upstream of the SCR may be below a threshold level. In this manner, in response to the first condition, slipped hydrocarbons may be prevented from entering U-SCR 208, where they can reduce the efficiency and shorten the useable life of U-SCR 208. Further still, the first condition may correspond to conditions where the NOx concentration in the exhaust upstream of the SCR is below a threshold NOx level (e.g. below the regulated NOx emission level). Under these conditions, SCR bypass valve 280 may also direct flow to bypass U-SCR.

In configuration 230, U-SCR 208, urea dosing injector 205, urea storage tank 203, and DPF 210 may operate as previously described in configuration 200. NOx can be reduced in U-SCR 208, reacting with ammonia reductant produced in CO trap 232 and/or formed from decomposition of urea injected upstream of U-SCR 208 at urea dosing injector 205. The efficiency and useful operating life of U-SCR 208 be prolonged by bypassing U-SCR in response to a first condition where the temperature is below a threshold temperature and/or the hydrocarbon concentration exceeds a threshold level. During periods of vehicle operation where exhaust flow bypasses U-SCR 208, urea dosing injector may cease urea injection.

Referring now to FIG. 2D, a fourth configuration 240 of a vehicle engine emission system is shown, wherein an exhaust gas flows sequentially from an engine 10 through a diesel oxidation catalyst (DOC) 204, an HC trap 222, and a carbon monoxide (CO) trap 232. Fourth configuration 240 is identical to the third configuration 230, except the sequence of HC trap 222 and CO trap 232 are switched so that HC trap 222 is upstream of CO trap 232. As such, hydrocarbons that are desorbed from HC trap 222 during regeneration of HC trap 222, may be trapped or converted (e.g. via NOx reduction reactions) in CO trap 232. In the fourth configuration 240, sensors 202, 205 and 207, and DOC 204, U-SCR 208, urea dosing injector 205, urea storage tank 203, and DPF 210 may operate as previously described in the third configuration 230. NOx can be reduced in U-SCR 208, reacting with ammonia reductant produced in CO trap 232 and/or formed from decomposition of urea injected upstream of U-SCR 208 at urea dosing injector 205. The efficiency and useful operating life of U-SCR 208 can be prolonged by bypassing U-SCR in response to a first condition where an emissions control device (e.g., DOC 204 and/or U-SCR 208) temperature is below a threshold temperature and/or the hydrocarbon concentration downstream of an emissions control device but upstream of the SCR (e.g., U-SCR 208) exceeds a threshold level or an integrated amount. Further still, the first condition may correspond to conditions where the NOx concentration in the exhaust is below a threshold NOx level (e.g. below the regulated NOx emission level). Under these conditions, SCR bypass valve 280 may also direct flow to bypass U-SCR.

Referring now to FIG. 2E a fifth configuration 250, of a vehicle engine emission system is shown, wherein an exhaust gas flows sequentially from an engine 10 through DOC 204, an HC trapping or zeolite material 252, and a carbon monoxide (CO) trap 232 upstream of an SCR bypass valve 280. Configuration 250 is similar to configuration 240, except that the HC trap 222 is replaced with an HC trapping or zeolite material 252. Temperature sensor 202 and hydrocarbon sensor 207 are located upstream of SCR bypass valve 280, the hydrocarbon sensor 207 being located downstream of the last emissions control device (e.g. CO trap 232) upstream of SCR bypass valve 280. Temperature sensor 202 may also be located at a device, for example DOC 204, thereby measuring the temperature at that device. Sensors 202 and 207 communicate with controller 12, which outputs signals to operate SCR bypass valve 280. In response to a first condition, SCR bypass valve 280 is manipulated by controller 12 to direct exhaust flow to bypass U-SCR. The first condition can correspond to when a temperature, indicated by sensor 202, is less than a threshold temperature and/or when the exhaust hydrocarbon concentration indicated by hydrocarbon sensor 207 is greater than a threshold level. The threshold level may also be an integrated hydrocarbon concentration or a threshold hydrocarbon concentration. Further still, the first condition may refer to a condition where NOx concentration in the exhaust is below a threshold NOx level. In some examples, sensor 202 may further comprise a NOx sensor. HC trapping or zeolite material 252 operates similarly to HC trap 222 described previously, where hydrocarbons flowing through HC trapping or zeolite material 252 are retained and entrapped. HC trapping or zeolite material 252 thus can trap slipped hydrocarbons downstream from DOC 204 (e.g. during cold engine starts or hydrogen concentrations above a threshold level).

Referring now to FIG. 2F, a sixth configuration 260 of a vehicle engine emission system is shown, wherein an exhaust gas flows sequentially from an engine 10 through a hydrocarbon and/or carbon monoxide (HC/CO) trap 262, followed by a metal oxidation catalyst 264. HC/CO trap 262 may operate similarly to the HC trap 222 and CO trap 232 in series previously described in configurations 230 and 240, retaining hydrocarbons and carbon monoxide from the exhaust gas flowing through HC/CO trap 262. Accordingly, HC/CO trap 262 may comprise a zeolitic material having molecular sieve properties, and may also comprise an LNT trap. As such, NOx may also be adsorbed in the HC/CO trap 262 during lean conditions and NOx may be desorbed and reduced during rich conditions. During rich conditions, when NOx may be desorbed and reduced, HC/CO trap 262 may also form ammonia. Thus, HC/CO trap 262 may comprise a combination of HC trap 222 and CO trap 232 in a single device. Metal oxidation catalyst 264 may be located downstream of HC/CO trap 262. Metal oxidation catalyst 264 can comprise a platinum group metal (PGM) or a base metal oxidation catalyst. Examples of platinum group metals include platinum, ruthenium, rhodium, iridium, osmium, and palladium. Examples of base metals include vanadium, molybdenum, tungsten, iron or copper. Metal oxidation catalyst 264 can oxidize hydrocarbons in the exhaust gas, converting the hydrocarbons to carbon dioxide and water. Temperature sensor 202 and hydrocarbon sensor 207 are located upstream of SCR bypass valve 280, the hydrocarbon sensor 207 being located downstream of the last emissions control device (e.g. metal oxidation catalyst 264) upstream of SCR bypass valve 280. Temperature sensor 202 may also be located at a device, for example DOC 204, thereby measuring the temperature at that device. Sensors 202 and 207 communicate with controller 12, which outputs signals to operate SCR bypass valve 280. During a first condition, SCR bypass valve 280 is manipulated by controller 12 to direct exhaust flow to bypass U-SCR. The first condition can correspond to a condition when a temperature, indicated by sensor 202, is less than a threshold temperature and/or when the exhaust hydrocarbon concentration indicated by hydrocarbon sensor 207 is greater than a threshold level. The threshold level may also be an integrated hydrocarbon concentration. Further still, the first condition may refer to a condition where NOx concentration in the exhaust is below a threshold NOx level. In some examples, sensor 202 may further comprise a NOx sensor. By diverting exhaust flow containing slipped hydrocarbons to bypass U-SCR 208 in response to a first condition, the lifetime and efficiency of U-SCR 208 can be prolonged. In response to a second condition, where the temperature reaches or exceeds a threshold temperature, or the hydrocarbon concentration is reduced below a threshold level, SCR bypass valve may be adjusted by controller 12 to direct exhaust to pass through U-SCR 208.

Referring now to FIG. 3, it illustrates a flowchart for an example method 300 of operating a vehicle engine emission system, comprising an SCR catalyst and an SCR bypass valve. Method 300 may be stored as executable instructions in non-transitory memory of controller 12. Further, method 300 may be executed by controller 12. Namely, method 300 evaluates if the current engine operating conditions satisfy a first condition, and if so, opens the SCR bypass valve to direct exhaust flow to bypass the SCR catalyst in order to prolong the life and efficiency of the SCR catalyst. For example, a first condition may be satisfied if a measured emissions control device temperature is below a threshold temperature and/or if a measured hydrocarbon concentration is greater than a threshold level. Under these conditions, the exhaust flow may be directed to bypass the SCR catalyst; if exhaust flow is directed to flow through the SCR catalyst, hydrocarbons in the exhaust may reduce the efficiency and decrease the useable life of the SCR catalyst. Conversely, if the measured temperature is greater than a threshold temperature, the SCR catalyst may not be bypassed because exhaust hydrocarbons can be oxidized in an emission device (e.g. DOC 204) or otherwise converted or consumed upstream of the SCR in the vehicle engine emission system. Thus, exhaust flow may be directed via the bypass valve in response to the emissions control device temperature. An example of an SCR catalyst is a U-SCR catalyst such as U-SCR 208 previously described in FIGS. 2A-2F. An example of an SCR bypass valve is SCR bypass valve 280 previously described in FIGS. 2C-2F.

Method 300 begins at step 302, where engine operating conditions are determined. Step 302 can comprise determining current vehicle engine emission system conditions such as temperatures, NOx and hydrocarbon concentrations, and the like. These conditions may be provided by a combination of sensors in the vehicle emission system such as sensors 125, 127, 202, and 207 previously described in FIGS. 1 and 2A-2F.

Method 300 continues at step 304 where it may evaluate whether or not a first condition is satisfied. For example, step 304 may determine if a measured temperature at the SCR or other vehicle engine emission system device is greater than a threshold temperature. The measured temperature may also be determined upstream of vehicle engine emission devices, for example, as shown by the location of sensor 202 in FIGS. 2A-2F. Alternately, the temperature may be measured at a device, such as at emissions device 70 as shown in FIG. 1, or at U-SCR 208. As an example, the threshold temperature may correspond to a light-off or initiation temperature (e.g. 200° C.) of an oxidation catalyst in emissions control device 70, for example DOC 204 or metal oxidation catalyst 264. If the measured temperature is greater than the threshold temperature, method 300 proceeds to step 314, where the SCR bypass valve is closed, directing exhaust to pass through the SCR catalyst. After step 314, method 300 ends. If the measured temperature is less than the threshold temperature, method 300 continues to step 306, to further evaluate if exhaust flow should bypass the SCR catalyst.

At step 306, the hydrocarbon concentration is measured downstream of the last emissions control device upstream of the SCR catalyst. Next, at step 308, the hydrocarbon concentration may be integrated over time to determine the total (integral) amount of hydrocarbons delivered to the SCR. Continuing at step 310, method 300 may determine if the integrated hydrocarbon concentration is greater than a threshold level. If the integrated hydrocarbon concentration is not greater than a threshold level, method 300 proceeds to step 314, where the SCR bypass valve is closed, and exhaust flow is directed through the SCR catalyst. After step 314, method 300 ends. If the integrated hydrocarbon concentration is greater than the threshold level, then method 300 continues to step 312 where the SCR bypass valve is opened, directing exhaust flow to bypass the SCR catalyst. In step 310, the threshold level may also be an instantaneous hydrocarbon concentration, whereby the threshold level is compared with an instantaneous hydrocarbon concentration to determine whether or not to open the SCR bypass valve.

As shown in FIG. 3, in response to a first condition where both the measured temperature of the emissions control device is below the threshold temperature and the hydrocarbon concentration exceeds a threshold level, method 300 operates the SCR bypass valve to direct exhaust to bypass the SCR catalyst. In other examples, the SCR bypass valve may direct exhaust to bypass the SCR catalyst in response to a first condition when either the measured emissions control device temperature is below the threshold temperature or the hydrocarbon concentration exceeds a threshold level. Furthermore, in response to a second condition, where either the measured emission control device temperature exceeds the threshold temperature, or the hydrocarbon concentration is lower than a threshold level, the SCR bypass valve directs exhaust to pass though the SCR catalyst.

As such method is presented for operating an engine emission system, comprising directing engine hydrocarbons to bypass an SCR catalyst via an SCR bypass valve in response to a first condition, and directing engine hydrocarbons through the SCR catalyst in response to a second condition. In some examples, the first condition is before an emissions control device in the engine emission system reaches a threshold temperature, wherein the emissions control device is an oxidation catalyst and can also comprise a hydrocarbon trap and/or a CO trap and/or a diesel particulate filter. In further examples, the second condition is after the emissions control device reaches the threshold temperature, or after the hydrocarbon concentration upstream of the SCR bypass valve is reduced below the threshold level. In further examples, the SCR catalyst is a urea SCR catalyst that converts NOx to N₂ and H₂O, and the first condition is where a hydrocarbon concentration upstream of the SCR bypass valve exceeds a threshold level. The hydrocarbon concentration upstream of the SCR bypass valve can be determined downstream of a last emissions control device upstream of the SCR catalyst, and further, the hydrocarbon concentration upstream of the SCR bypass valve can be determined via a hydrocarbon sensor. The hydrocarbon concentration upstream of the SCR bypass valve may be an integrated hydrocarbon concentration and the threshold level may be an integrated hydrocarbon concentration threshold.

Referring now to FIG. 4, an example simulated plot of signals of interest when monitoring a vehicle engine emission system is shown. The sequence of FIG. 4 may be provided via controller 12 executing instructions of the method 300 shown in FIG. 3. For example, if a measured emissions control device temperature is less than a threshold temperature and the exhaust hydrocarbon concentration is greater than a threshold level, a first condition is satisfied, and in response, the SCR bypass valve is adjusted to direct exhaust flow to bypass the SCR catalyst. In response to the first condition, the exhaust flow is directed to bypass the SCR catalyst because hydrocarbon concentration in the exhaust may be detrimental to the efficiency and useful life of the SCR catalyst. In response to a second condition being satisfied, wherein either a measured emissions control device temperature is greater than a threshold temperature, or the exhaust hydrocarbon concentration is less than a threshold level, the SCR bypass valve is adjusted to direct exhaust flow to pass through the SCR catalyst. Vertical markers T₀₋T₄ indicate times of particular interest in the sequence. FIG. 4 includes five example timeline plots and each of the five plots includes an X axis that represents time. Time increases from the left side of FIG. 4 to the right side of FIG. 4 in the direction of the X axis arrows.

The first plot from the top of FIG. 4 represents an engine speed 410. As shown in FIG. 4, at time T₀ the engine is started, the engine speed increasing from an idle state. Shortly after, at time T₁, the engine speed increases sharply, for example as the vehicle motion commences. Also at T₁, early combustion events cause engine speed to increase and give rise to engine hydrocarbon emissions as indicated by hydrocarbon signal 430. In this example scenario, the engine start may be a warm start, as indicated by the exhaust system temperature signal 450, where the measured temperature is greater than a threshold temperature 454. The exhaust system temperature may be a measured temperature upstream or downstream of one or more emissions control devices in the exhaust system or a measured temperature at one or more of the emissions control devices in the exhaust system. Further, the exhaust system temperature may be measured by a sensor located at the exhaust system that communicates with controller 12 or may be an inferred temperature that is calculated from other sensor signals or calculated at controller 12. For example, the exhaust system temperature may be a measured temperature in the exhaust upstream of an emissions control device 70, or may measure the temperature of an emissions control device 70 such as DOC 204 or of an SCR catalyst. Because the exhaust system temperature is greater than a threshold temperature, hydrocarbon emissions from the engine may be oxidized upstream of the SCR catalyst, for example by a diesel oxidation catalyst 204. Consequently, the HC sensor output signal 440 (located downstream of the last emissions control device upstream of the SCR catalyst) indicates a hydrocarbon concentration that is less than a threshold level 444. In some examples, HC sensor output may represent an integrated hydrocarbon concentration signal and threshold level 444 may represent an integrated hydrocarbon concentration threshold. HC sensor output may also represent a measured hydrocarbon concentration or an inferred hydrocarbon concentration in the exhaust system. Because the exhaust system temperature 450 is greater than a temperature threshold 454, and because the HC sensor output 440 is less than the threshold level 444, the second condition may be satisfied and the SCR bypass valve position 420 is adjusted to direct exhaust flow to pass through the SCR catalyst.

At time T₂, the vehicle engine speed 410 is rapidly increased, for example during a period of vehicle acceleration, at which time an increase in engine hydrocarbon emissions 430 (e.g., due to air/fuel imbalance) and measured temperature 450 occurs. Furthermore, the HC sensor output 440 increases above the threshold level 444. Accordingly, controller 12 may throttle SCR bypass valve position 420 to direct the exhaust flow to bypass the SCR catalyst at time T₂.

Next, at time T₃, the engine speed is momentarily reduced, at which time a drop in the hydrocarbon sensor output 440 occurs such that the hydrocarbon concentration is below the threshold level 444. As such, the SCR bypass valve is adjusted to allow exhaust flow to pass through the SCR catalyst.

At time T₄, the engine speed 410 is once again increased, for example when the vehicle ascends an incline in the road. Because the HC sensor output 440 increases above the threshold level 444, SCR bypass valve is adjusted to direct exhaust flow to bypass the SCR catalyst. In this manner, FIG. 4 illustrates various scenarios where the SCR bypass valve may be operated to prolong the efficiency and life of an SCR catalyst.

Referring now to FIG. 5, a further example simulated plot of signals of interest when monitoring a vehicle engine emission system is shown. As in FIG. 4, the same group of signals representing engine speed 410, SCR bypass valve position 420, engine hydrocarbon emissions 430, HC sensor output 440, and measured temperature 450 are shown. As in FIG. 4, the signals shown in FIG. 5 may be provided via controller 12 executing instructions of the method shown in FIG. 3. In addition the threshold level 444 and threshold temperature 454 are shown on the plots of HC sensor output 440 and measured temperature 450 respectively.

As shown, engine speed 410 has a similar profile with increasing time as the engine speed signal in FIG. 4. However, in FIG. 5, the vehicle is started cold, the measured temperature 450 gradually increasing with time from time T₅ to time T₉, and not exceeding the threshold temperature 454 until after time T₉. As such, engine hydrocarbon emissions 430 may not be completely oxidized upstream of the HC sensor location in the vehicle engine emission system, as indicated by the HC sensor output signal 440, which shows a hydrocarbon concentration greater than the threshold level 444 during a period between time T₅ to time T₉. Thus, the engine operating conditions satisfy the first condition during time T₅ to time T₉, wherein the measured temperature 450 is below the temperature threshold 454 and the exhaust hydrocarbon concentration 440 is greater than a threshold level 444. As such, the SCR bypass valve position is adjusted to direct exhaust flow to bypass the SCR catalyst during the period from time T₅ to time T₉. After time T₉, the measured temperature 450 becomes greater than the threshold temperature 454 and the HC sensor output 544 indicates an exhaust hydrocarbon concentration 440 below the threshold level 444. Accordingly, the second condition is satisfied, and controller 12 may adjust the SCR bypass valve position to direct exhaust flow to pass through the SCR catalyst. In this manner, FIG. 5 illustrates various further scenarios where the SCR bypass valve may be operated to prolong the efficiency and life of an SCR catalyst.

As such, a vehicle engine emission system comprising an emissions control device, an SCR catalyst, an SCR bypass valve located upstream from the SCR catalyst, and a controller, including executable instructions to direct exhaust flow to bypass the SCR catalyst in response to a first condition, and to direct exhaust flow to pass through the SCR catalyst in response to a second condition, is described. The emissions control device comprises an oxidation catalyst and/or a hydrocarbon trap, and/or a CO trap upstream from the SCR catalyst, and/or a diesel particulate filter downstream from the SCR catalyst. Further, the first condition may comprise before an emissions control device in the vehicle engine emission system reaches a threshold temperature, and the second condition may comprise after the emissions control device reaches the threshold temperature. The SCR catalyst of the vehicle engine emission system may comprise a urea SCR catalyst that converts NOx to N₂ and H₂O, wherein the first condition may include where a hydrocarbon concentration upstream of the SCR bypass valve exceeds a threshold level.

As will be appreciated by one of ordinary skill in the art, the method described in FIG. 3 may represent one or more of any number of processing strategies such as event-driven, interrupt-driven, multi-tasking, multi-threading, and the like. As such, various steps or functions illustrated may be performed in the sequence illustrated, in parallel, or in some cases omitted. Likewise, the order of processing is not necessarily required to achieve the objects, features, and advantages described herein, but is provided for ease of illustration and description. Although not explicitly illustrated, one of ordinary skill in the art will recognize that one or more of the illustrated steps, methods, or functions may be repeatedly performed depending on the particular strategy being used.

It will be appreciated that the configurations and routines disclosed herein are exemplary in nature, and that these specific examples are not to be considered in a limiting sense, because numerous variations are possible. For example, the above technology can be applied to various vehicle engine emission system configurations comprising an SCR catalyst, and can further comprise devices such as diesel or other types of oxidation catalysts, zeolites, lean NOx traps, hydrocarbon traps, carbon monoxide traps, diesel and other types of particulate filters, and other devices known in the art. Further, evaluating conditions under which exhaust flow is directed to bypass the SCR catalyst may comprise measuring various exhaust parameters such as temperature and exhaust component concentrations, including integrated signals thereof, derivative signals thereof, sums of signals thereof, and the like, and may comprise combinations of parameters and signals. The subject matter of the present disclosure includes all novel and non-obvious combinations and sub-combinations of the various systems and configurations, and other features, functions, and/or properties disclosed herein.

The following claims particularly point out certain combinations and subcombinations regarded as novel and non-obvious. These claims may refer to “an” element or “a first” element or the equivalent thereof. Such claims are to be understood to include incorporation of one or more such elements, neither requiring nor excluding two or more such elements. Other combinations and subcombinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method for operating an engine emission system, comprising:
directing engine hydrocarbons from upstream of an SCR catalyst, around the SCR catalyst, then downstream of the SCR catalyst to bypass the SCR catalyst via an SCR bypass valve responsive to a first condition where a hydrocarbon concentration exceeds a threshold level; and
directing engine hydrocarbons through the SCR catalyst in response to a second condition.

2. (canceled)

3. The method of claim 1, where the engine hydrocarbons are directed from an oxidation catalyst directly downstream of the SCR catalyst responsive to the first condition, and where the engine hydrocarbons are directed from the oxidation catalyst through the SCR catalyst responsive to the second condition.

4. (canceled)

5. The method of claim 1, where the SCR catalyst is a urea SCR catalyst that converts NOx to N₂ and H₂O, and where the first condition is where the hydrocarbon concentration upstream of the SCR bypass valve exceeds the threshold level.

6. The method of claim 5, where the second condition is after the hydrocarbon concentration upstream of the SCR bypass valve is reduced below the threshold level.

7. The method of claim 6, where the hydrocarbon concentration upstream of the SCR bypass valve is determined downstream of a last emissions control device upstream of the SCR catalyst.

8. The method of claim 7, where the hydrocarbon concentration upstream of the SCR bypass valve is determined via a hydrocarbon sensor.

9. The method of claim 8, where the hydrocarbon concentration upstream of the SCR bypass valve is an integrated hydrocarbon concentration and the threshold level is an integrated hydrocarbon concentration threshold.

10. The method of claim 3, where the engine hydrocarbons are directed from the oxidation catalyst, to hydrocarbon trap, then directly downstream of the SCR catalyst responsive to the first condition, and where the engine hydrocarbons are directed from the oxidation catalyst, to the hydrocarbon trap, then through the SCR catalyst responsive to the second condition.

11. The method of claim 10, where the engine hydrocarbons are directed from the oxidation catalyst, to a CO trap, to the hydrocarbon trap, then directly downstream of the SCR catalyst responsive to the first condition, and where the engine hydrocarbons are directed from the oxidation catalyst, to the CO trap, to the hydrocarbon trap, then through the SCR catalyst responsive to the second condition.

12. The method of claim 3, where the engine hydrocarbons are directed from the oxidation catalyst, around the SCR catalyst, then directly to a diesel particulate filter responsive to the first condition, and where the engine hydrocarbons are directed from the oxidation catalyst, through the SCR catalyst, then to the diesel particulate filter responsive to the second condition.

13-20. (canceled)

21. A method for operating an engine emission system, comprising:
directing engine hydrocarbons from upstream of an SCR catalyst, around the SCR catalyst, then directly to a diesel particulate filter positioned downstream of the SCR catalyst to bypass the SCR catalyst via an SCR bypass valve responsive to a first condition; and
directing engine hydrocarbons through the SCR catalyst to the diesel particulate filter in response to a second condition.

22. The method of claim 21, where the first condition is before an emissions control device in the engine emission system reaches a threshold temperature and the second condition is after the emissions control device reaches the threshold temperature.

23. The method of claim 22, where the emissions control device is an oxidation catalyst.

24. The method of claim 21, where the SCR catalyst is a urea SCR catalyst that converts NOx to N₂ and H₂O, and where the first condition is where a hydrocarbon concentration upstream of the SCR bypass valve exceeds a threshold level.

25. The method of claim 24, where the second condition is after the hydrocarbon concentration upstream of the SCR bypass valve is reduced below the threshold level.

26. The method of claim 25, where the hydrocarbon concentration upstream of the SCR bypass valve is determined downstream of a last emissions control device upstream of the SCR catalyst.

27. The method of claim 26, where the hydrocarbon concentration upstream of the SCR bypass valve is determined via a hydrocarbon sensor.

28. The method of claim 27, where the hydrocarbon concentration upstream of the SCR bypass valve is an integrated hydrocarbon concentration and the threshold level is an integrated hydrocarbon concentration threshold.

29. The method of claim 23, where the emissions control device further comprises a hydrocarbon trap.

30. The method of claim 29, where the emissions control device further comprises a CO trap.
